(19) United States
(12) Patent Application Publication
(10) Pub. No.: US 2025/0118774 A1
(43) Pub. Date: Apr. 10, 2025

(54) TUBULAR FLOW BATTERY DESIGN HAVING SOLID ANODE BODY

(71) Applicant: The Sun Company Americas, Inc., Tucson, AZ (US)

(72) Inventors: Joley Dale Michaelson, Tucson, AZ (US); Kevin Philip Meagher, Raleigh, NC (US); David Brian Jackson, Spanish Fork, UT (US)

(73) Assignee: The Sun Company Americas, Inc., Tucson, AZ (US)

(21) Appl. No.: 18/894,817

(22) Filed: Sep. 24, 2024

Related U.S. Application Data
(60) Provisional application No. 63/542,615, filed on Oct. 5, 2023.

(51) Int. Cl. H01M 8/0252; H01M 4/90; H01M 4/96; H01M 8/18; H01M 12/08

(52) U.S. Cl. CPC H01M 8/0252; H01M 4/9041; H01M 4/96; H01M 8/188; H01M 12/08

(57) ABSTRACT

A cylindrical reactor for a flow battery includes a solid anode body with through-holes through which hollow membrane tubes extend. The hollow membrane tubes surround cathodic wires. A first electrolyte is pumped in from a first electrolyte tank between the cathodic wires and the hollow membrane tubes, while a second electrolyte is pumped in from a second electrolyte tank between the hollow membrane tubes and the surrounding portion of the solid anode body. Redox half reactions between the first electrolyte and the second electrolyte are thereby able to happen across the hollow membrane tubes.

### CROSS REFERENCES TO RELATED APPLICATIONS

This application is related to and claims priority from the following U.S. patents and patent applications. This application claims priority to and the benefit of U.S. Provisional Patent Application No. 63/542,615, filed Oct. 5, 2023, which is incorporated herein by reference in its entirety.

### BACKGROUND OF THE INVENTION

### 1. Field of the Invention

The present invention relates to redox flow batteries, and more specifically to redox flow batteries having a tubular design with a solid anode design.

### 2. Description of the Prior Art

It is generally known in the prior art to provide flow batteries, generally with a planar design with a permeable membrane allowing for ion exchange between flowing anolyte and catholyte.

Prior art patent documents include the following:

US Patent Pub. No. 2022/0123346 for Multi-cell flow battery and fuel cell assemblies by inventors Park et al., filed Oct. 20, 2021 and published Apr. 21, 2022, discloses a multi-cell electrochemical reaction cell structure for a flow battery or fuel cell having a plurality of cells electrically connected in series or parallel. A first housing has a pair of mating end plates assembled together, each forming a plurality of recesses in which one of the cells is received. One of the end plates has a projection along its perimeter and the other one of the end plates has a groove along its perimeter. The projection is configured to fit within the groove in a mating relationship to seal the housing when the end plates are engaged with each other. A second housing is a tubular shell in which a plurality of tubular flow cell units electrically connected in parallel are housed. Catholyte flows in the tubular flow cell units and anolyte flows in the tubular shell.

U.S. Pat. No. 9,786,944 for High energy density redox flow device by inventors Chiang et al., filed Dec. 16, 2010 and issued Oct. 10, 2017, discloses redox flow devices in which at least one of the positive electrode or negative electrode-active materials is a semi-solid or is a condensed ion-storing electroactive material, and in which at least one of the electrode-active materials is transported to and from an assembly at which the electrochemical reaction occurs, producing electrical energy. The electronic conductivity of the semi-solid is increased by the addition of conductive particles to suspensions and/or via the surface modification of the solid in semi-solids (e.g., by coating the solid with a more electron conductive coating material to increase the power of the device). High energy density and high power redox flow devices are disclosed. The redox flow devices described herein can also include one or more inventive design features. In addition, inventive chemistries for use in redox flow devices are also described.

U.S. Pat. No. 9,608,286 for Method of charging/discharging power through pipelines flown with electrolytes and apparatus using the same by inventors Chang et al., filed Apr. 27, 2015 and issued Mar. 28, 2017, discloses pipelines used for charging and discharging power in a redox flow battery (RFB). Inner tube made of ion-exchange material is inserted into each of the pipelines. Conductive sleeves are installed on inside and outside the inner tube. Anode electrolyte and cathode electrolyte flow into corresponding ones of the pipelines of the inner tube. Thereby, wires connected with the conductive sleeves are extended out to be used as electrodes. On charging power, the anode electrolyte and the cathode electrolyte flow forwardly; yet, on discharging power, the anode electrolyte and the cathode electrolyte flow backwardly. Thus, the present invention uses pipelines to add or supplement function of charging/discharging power. Even when the RFB is damaged or failed, power is still charged/discharged for effectively improving or ensuring efficiency of the battery.

U.S. Pat. No. 11,824,243 for Electrode assembly and flow battery with improved electrolyte distribution by inventors Klassen et al., filed Dec. 14, 2022 and issued Nov. 21, 2023, discloses an electrode assembly for a flow battery comprising a porous electrode material, a frame surrounding the porous electrode material, at least a distributor tube embedded in the porous electrode material having an inlet for supplying electrolyte to the porous electrode material and at least another distributor tube embedded in the porous electrode material having an outlet for discharging electrolyte out of the porous material. The walls of the distributor tubes are preferably provided with holes or pores for allowing a uniform distribution of the electrolyte within the electrode material. The distributor tubes provide the required electrolyte flow path length within the electrode material to minimize shunt current flowing between the flow cells in the battery stack.

Chinese Patent No. 109346754 for High-power-density flow battery, filed Oct. 17, 2018 and issued Feb. 15, 2022, discloses a high-power-density flow battery, which comprises a cylinder body, an upper end enclosure and a lower end enclosure, wherein the upper end enclosure and the lower end enclosure are respectively connected with the cylinder body, a first electrolyte inlet is arranged on the upper end enclosure, a first electrolyte outlet is arranged on the lower end enclosure, a second electrolyte inlet and a second electrolyte outlet are arranged on the cylinder body, an upper end enclosure and a lower end enclosure are respectively arranged at the end part of the cylinder body, the upper end enclosure and the lower end enclosure are respectively connected with a hollow separation membrane, a first electrode is arranged on the inner side of the hollow separation membrane, and a second electrode is arranged on the outer side of the hollow separation membrane and the inner side of the cylinder body. The flow battery has the advantages that the filling density of the electrode is high, the contact area of the electrolyte and the electrode is large, the electrochemical reaction can be rapidly carried out on the surface of the electrode, and the electrochemical polarization of the battery is reduced. The tubular separation membrane of the flow battery can be filled with hollow fiber membranes with small pipe diameters in a large density, so that the membrane area of the unit volume in the battery is increased, and the power density of the battery in the unit volume is increased.

Article “A Co-Axial Microtubular Flow Battery Cell with Ultra-high Volumetric Power Density” by authors Wu et al., published Feb. 14, 2022, discloses that volumetric power density is a key factor determining flow batteries' footprint, capital cost and ability to handle uneven energy resource distributions. While significant progress has been made on flow battery materials and electrochemistry to improve energy density, conventional flow battery assemblies based on planar cell configuration exhibit low packing efficiencies and membrane surface area per volume of the cell, thus resulting in low volumetric power density. Here, we introduce a co-axial microtubular (CAMT) flow battery cell that significantly improves the volumetric power density. This cell design overcomes the intrinsic power limit of planar cell configuration and is suitable for all mainstream flow battery chemistries. Using zinc-iodide chemistry as a demonstration, our CAMT cell shows peak charge and discharge power densities of 1322 W/Lcell and 306.1 W/Lcell compared to average charge and discharge power densities of <60 W/Lcell and 45 W/Lcell of conventional planar flow battery cells. In addition, the battery can cycle for more than 220 hours, corresponding to >2,500 cycles at off-peak conditions. Furthermore, we have also demonstrated that the CAMT cell is compatible with zinc-bromide, quinone-bromide, and all-vanadium chemistries. The CAMT flow cell represents a device-level innovation to enhance the volumetric power of flow batteries, and potentially reduce the size and cost of the cells and the entire flow battery. The CAMT design can potentially be applied to other electrochemical systems and lead to a paradigm shift in flow battery fundamental study and commercialization.

Article “An all-extruded tubular vanadium redox flow cell-Characterization and model-based evaluation” by authors Ressel et al., published December 2021, discloses that the vanadium redox flow battery (VRFB) as one of the most promising electrochemical storage systems for stationary applications still needs further cost reductions. Tubular cell designs might reduce production costs by extrusion production of cell components and small sealing lengths. Based on a first study of the authors, this work demonstrates the feasibility of extruded tubular VRFB cells with high power density in the flow-by electrode configuration. Extruded cell components are the perfluorosulfonic acid cation exchange membrane with a diameter of 5.0 mm and carbon composite current collectors. The cell performance is experimentally characterized by polarization curve, ohmic resistance and galvanostatic cycling measurements. A maximum volumetric power density of 407 kW/m3 and a maximum current density of 500 mA/cm2 can be achieved. A non linear Ecell/i-model is used to evaluate exchange and limiting current densities while in-situ half cell SoC monitoring is applied to evaluate the extruded membrane.

Article “Development and Performance Analysis of a Low-Cost Redox Flow Battery” by authors Huq et al., published Jul. 12, 2024, discloses that redox Flow Batteries (RFBs) offer a promising solution for energy storage due to their scalability and long lifespan, making them particularly attractive for integrating renewable energy sources with fluctuating power output. This study investigates the performance of a prototype Zinc-Chlorine Flow Battery (ZCFB) designed for low-cost and readily available electrolytes. The ZCFB utilizes a saltwater electrolyte containing ZnCl₂ and NaCl, paired with a mineral spirits catholyte. The electrolyte consists of a 4 M ZnCl₂ and a 2 M NaCl solution, both with a pH of 4.55. The anode was a zinc metal electrode, while the cathode comprised a porous carbon electrode on a titanium grid current collector. The cell volume was approximately 4.0 mL, with separate reservoirs for the NaCl/H₂O and mineral spirits electrolytes. Experiments were conducted under constant current conditions, with a 0.2 A charging current and a 5 mA discharge current chosen for optimal cell voltage. The study analyzed the relationship between voltage, current, power, and capacity during both charging and discharging cycles. Results from multiple charge/discharge cycles found that the current density of the battery is around 62.658 mA/cm² with an energy capacity average of 1.2 Wh. These findings can contribute to the development of more efficient and practical ZCFBs, particularly for applications requiring low-cost and readily available electrolytes.

### SUMMARY OF THE INVENTION

The present invention relates to redox flow batteries, and more specifically to redox flow batteries having a tubular design with a solid anode design.

It is an object of this invention to provide a redox flow battery with a reduced footprint and increased power density.

In one embodiment, the present invention is directed to a flow battery reactor, including a solid anode body including a plurality of through-holes, a plurality of hollow membrane tubes extending through the plurality of through-holes, a plurality of cathode wires extending through the plurality of hollow membrane tubes, a first electrolyte intake configured to receive a first electrolyte, wherein the first electrolyte flows between interior surfaces of the plurality of through-holes and the plurality of hollow membrane tubes, and a second electrolyte intake configured to receive a second electrolyte, wherein the second electrolyte flows between the plurality of hollow membrane tubes and the plurality of cathode wires.

In another embodiment, the present invention is directed to a flow battery reactor, including an outer shell surrounding a solid anode body, wherein the solid anode body includes a plurality of through-holes, a plurality of hollow membrane tubes extending through the plurality of through-holes, a plurality of cathode wires extending through the plurality of hollow membrane tubes connected to a cathode contact extending from a first end of the reactor, and an anode contact connected to the solid anode body extending from a second end of the reactor.

In yet another embodiment, the present invention is directed to a flow battery reactor, including a solid anode body, wherein the solid anode body includes a plurality of through-holes, a plurality of hollow membrane tubes extending through the plurality of through-holes, and a plurality of cathode wires extending through the plurality of hollow membrane tubes, wherein the solid anode body comprises zinc, and wherein the plurality of cathode wires includes carbon fiber and/or carbon nanotube wires.

These and other aspects of the present invention will become apparent to those skilled in the art after a reading of the following description of the preferred embodiment when considered with the drawings, as they support the claimed invention.

### BRIEF DESCRIPTION OF THE DRAWINGS

FIG. 1A illustrates an external perspective view of a reactor for a flow battery according to one embodiment of the present invention.

FIG. 1B illustrates an external side view of the reactor of the flow battery shown in FIG. 1A.

FIG. 2 illustrates a side sectional view of a reactor of a flow battery according to one embodiment of the present invention.

FIG. 3A illustrates an external perspective view of a reactor for a flow battery according to one embodiment of the present invention.

FIG. 3B illustrates an external side view of the reactor of the flow battery shown in FIG. 3A.

FIG. 4A illustrates a perspective sectional view of a reactor for a flow battery according to one embodiment of the present invention.

FIG. 4B illustrates a side sectional view of the reactor for the flow battery shown in FIG. 4A.

FIG. 5 illustrates a perspective view of an anode body for a reactor for a flow battery according to one embodiment of the present invention.

FIG. 6 shows an enlarged schematic view of an ion exchange area of a reactor for a flow battery according to one embodiment of the present invention.

### DETAILED DESCRIPTION

The present invention is generally directed to redox flow batteries, and more specifically to redox flow batteries having a tubular design with a solid anode design.

In one embodiment, the present invention is directed to a flow battery reactor, including a solid anode body including a plurality of through-holes, a plurality of hollow membrane tubes extending through the plurality of through-holes, a plurality of cathode wires extending through the plurality of hollow membrane tubes, a first electrolyte intake configured to receive a first electrolyte, wherein the first electrolyte flows between interior surfaces of the plurality of through-holes and the plurality of hollow membrane tubes, and a second electrolyte intake configured to receive a second electrolyte, wherein the second electrolyte flows between the plurality of hollow membrane tubes and the plurality of cathode wires.

In another embodiment, the present invention is directed to a flow battery reactor, including an outer shell surrounding a solid anode body, wherein the solid anode body includes a plurality of through-holes, a plurality of hollow membrane tubes extending through the plurality of through-holes, a plurality of cathode wires extending through the plurality of hollow membrane tubes connected to a cathode contact extending from a first end of the reactor, and an anode contact connected to the solid anode body extending from a second end of the reactor.

In yet another embodiment, the present invention is directed to a flow battery reactor, including a solid anode body, wherein the solid anode body includes a plurality of through-holes, a plurality of hollow membrane tubes extending through the plurality of through-holes, and a plurality of cathode wires extending through the plurality of hollow membrane tubes, wherein the solid anode body comprises zinc, and wherein the plurality of cathode wires includes carbon fiber and/or carbon nanotube wires.

As markets and government policies continue to emphasize the importance of renewable energy for the power grid, one important issue to address is energy storage. Renewable energy sources such as solar and wind are very active in energy generation in certain time periods, while being almost entirely inactive in other time periods. In order to allow a grid to function using such time-limited energy generation, storing energy for longer periods of time is essential. Flow batteries have been a common area of research and development for meeting this need.

Flow batteries are advantageous over traditional solid state batteries, such as lithium ion batteries, for several reasons. One reason is that flow batteries are typically less flammable and less toxic than lithium ion batteries, allowing for reduced risk of damage to a power substation or other grid equipment. Additionally, while electrolyte needs to be replenished for the flow batteries, the batteries themselves tend to degrade at a far slower rate than lithium ion batteries, meaning reduced costs in the long term. Flow batteries also require less ambient temperature control, allowing for reduced costs on air conditioning or heating to allow the batteries to function in more extreme weather conditions. The biggest advantage, in terms of grid stability, is likely that flow batteries are able to maintain a charge for longer periods of time, with storage over a period of at least 12 hours, rather than merely approximately 4 hours for lithium ion batteries. Finally, flow batteries are able to be modular in nature, with the same electrolyte tanks used for multiple reactors in order to increase overall storage and output capabilities.

However, several aspects of flow batteries have prevented them from being as widely adopted as lithium ion batteries for grid level storage. One issue is their spatial footprint. Flow batteries require two electrolyte tanks in addition to a reactor, which sometimes takes up a large amount of space that a substation or other grid facility potentially does not have. Another issue, related to the large spatial footprint is the lower power density of flow batteries relative to lithium ion batteries, meaning that individual batteries are less able to support grid needs and larger or more batteries need to be used to support the same amount of power as the lithium ion batteries. Additionally, while some of the materials used to make flow batteries are lower cost than those used for lithium ion batteries, other costs, such as for operating pumps for pumping electrolyte from the tanks to the reactor, often offset the savings.

What is needed, and therefore what is addressed by the present invention, is a flow battery with improved power density and decreased spatial footprint. Furthermore, what is needed is a system capable of utilizing less expensive metal materials (e.g., zinc) rather than rarer metals (e.g., vanadium) for decreased cost relative to both prior art flow battery solutions and relative to traditional lithium ion batteries.

One way to address both manufacturing cost and spatial footprint of the flow battery is to examine the design of the reactor. Most prior art flow batteries designs utilize a parallel plate reactor set up, wherein catholyte flows through one plate and anolyte flows through an adjacent plate with a semi-permeable membrane disposed between the two plates. While simple, this design has low exchange surface area, therefore limiting energy density and power density of the device, and also requires large sealing surface areas that increase cost of manufacturing.

Recently, a few research teams have attempted cylindrical reactor designs for flow batteries to mitigate the amount of sealing area and to hopefully reduce the spatial footprint of the flow batteries, including those described in the articles “A Co-Axial Microtubular Flow Battery Cell with Ultra-high Volumetric Power Density” by Wu et al. and “An all-extruded tubular vanadium redox flow cell-Characterization and model-based evaluation” by Ressel et al. First, with regard to the Wu design, the reactor utilized zinc wires adjacent to the ion exchange membrane tubes to serve as the node for the reactor. This solution is limited with regard both to the surface area available for the reaction and, critically, with regard to the longevity of the anode in this system, as the thin Zinc anodes quickly degrade. In fact, the researchers propose, in this article, not changing the design of the anode, but rather the material to utilize carbon fiber instead. The outer electrode for the Ressel design similarly highly limits the exchange surface area, as it includes a graphite coating on an interior side of a cylindrical copper tube. The Ressel design, therefore, cannot reasonably be scaled up as the surface area-to-volume ratio quickly becomes untenable and inefficient.

Therefore, what is needed is a cylindrical design with improved exchange surface area and utilizing a design and/or materials that provide for improved power density over these previous cylindrical reactor designs and relative to prior art flow batteries in general.

Referring now to the drawings in general, the illustrations are for the purpose of describing one or more preferred embodiments of the invention and are not intended to limit the invention thereto.

The present invention is directed to a reactor component of a flow battery. The present invention is able to include catholyte and anolyte tanks configured to flow fluid catholyte and anolyte, respectively into the reactor of the present invention. The general arrangement of a flow battery, including connection of catholyte and anolyte tanks to a central reactor with pumps for pushing electrolyte through the system is described in numerous prior art patent documents, including, but not limited to, US Patent Pub. No. 2023/0130406, which is incorporated herein by reference in its entirety.

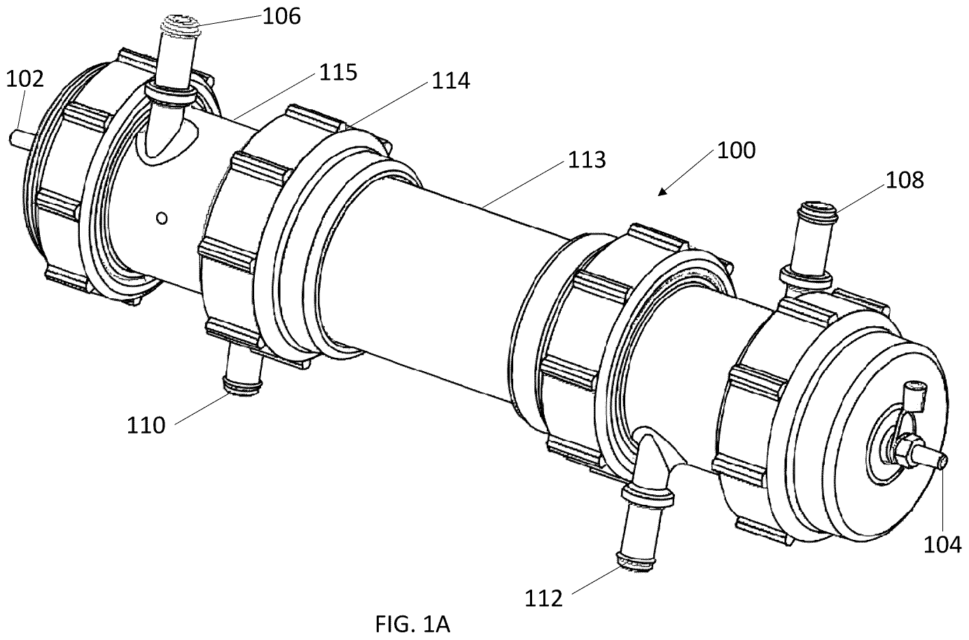

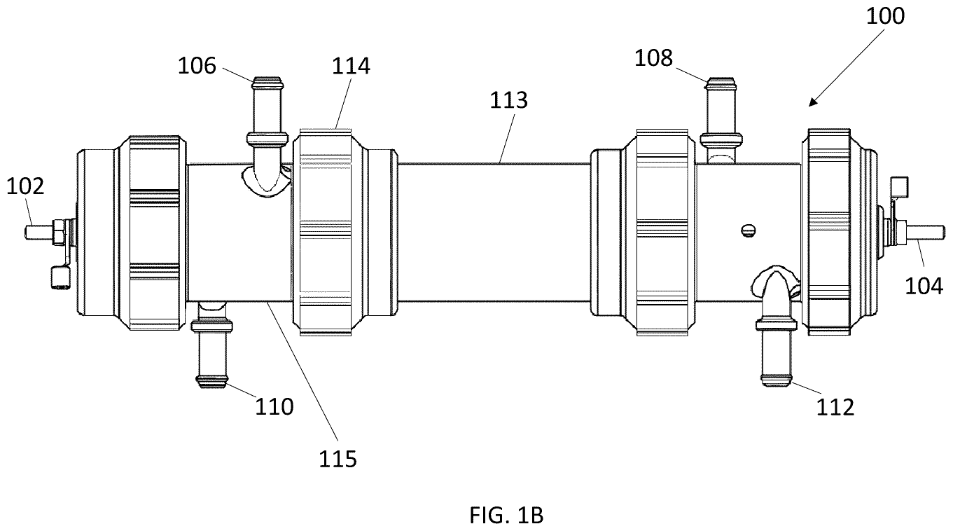

FIGS. 1A and 1B illustrate external views of a reactor for a flow battery according to one embodiment of the present invention. A reactor 100 includes a first electrolyte intake 106 and a first electrolyte exhaust 108. The reactor 100 further includes a second electrolyte intake 110 and a second electrolyte exhaust 108. The first electrolyte intake 106 is operable to be connected to a tube or other connection means to a first electrolyte tank. A pump is operable to pump the first electrolyte from the first electrolyte tank through the tube or other connection means into the reactor 100. The first electrolyte then flows through the reactor 100 and exits the reactor 100 through the first electrolyte exhaust 108. The first electrolyte exhaust 108 is also connected to the first electrolyte tank via a tube or other connection means. The second electrolyte intake 110 is operable to be connected to a tube or other connection means to a second electrolyte tank. A pump is operable to pump the second electrolyte from the second electrolyte tank through the tube or other connection means into the reactor 100. The second electrolyte then flows through the reactor 100 and exits the reactor 100 through the second electrolyte exhaust 112. The second electrolyte exhaust 112 is also connected to the second electrolyte tank via a tube or other connection means. One of ordinary skill in the art will understand that the first electrolyte is able to be the catholyte and the second electrolyte is able to be anolyte, or vice versa. Similarly, the reactor 100 is able to be configured to operate such that the first electrolyte exhaust 108 serves as the intake for the first electrolyte while the first electrolyte intake 106 serves as the exhaust for the first electrolyte. Additionally, the reactor 100 is able to be configured to operate such that the second electrolyte exhaust 112 serves as the intake for the second electrolyte while the second electrolyte intake 110 serves as the exhaust for the second electrolyte

At opposite ends of the reactor 100 are a first electrode contact 102 and a second electrode contact 104. In one embodiment, the first electrode contact 102 is an anode contact and the second electrode contact 104 is a cathode contact, or vice versa.

The reactor 100 is able to be configured such that it includes a central tubular section 113, which includes the bulk of the anode body and exchange areas, connected to end sections 115, including the electrode contact components, via ring connectors 114. This construction allows the end sections 115 to be more easily separated from the central tubular section 113 such that repairs to the contact areas do not require affecting the exchange areas or central anode body, and allowing for more robust and easy replacement of individual components of the reactor 100.

In one embodiment, the outer shell of the reactor 100 is formed from a plastic material (e.g., nylon 12, polyurethane, polypropylene, polycarbonate, high-density polyethylene, etc.), but one of ordinary skill in the art will understand that it is able to be formed from any material, so long as the material does not substantially affect the electrical properties of components within the shell.

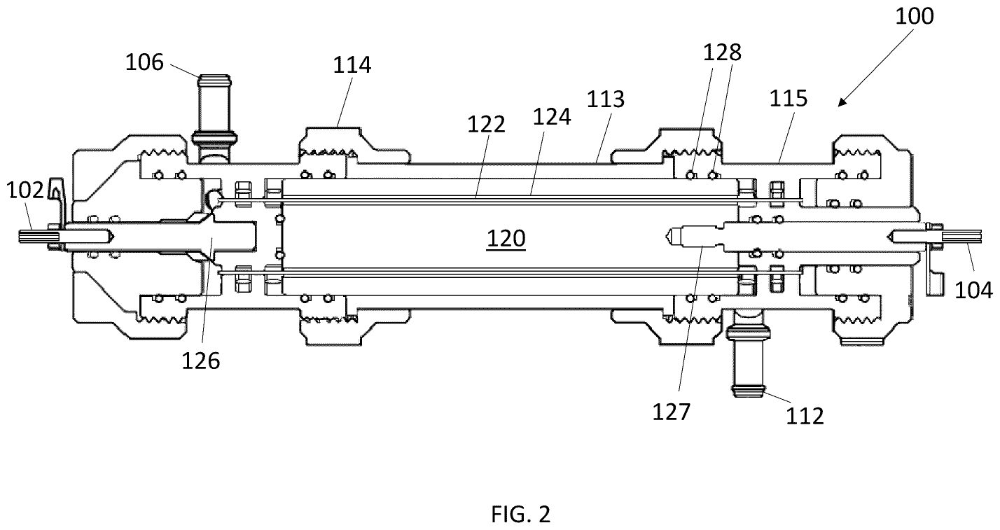

FIG. 2 illustrates a side sectional view of a reactor of a flow battery according to one embodiment of the present invention. The reactor 100 includes an anode body 120 disposed mostly within the central tubular section 113 of the reactor 100. The anode body 120 includes a plurality of through-holes through which hollow membrane tubes 124 extend. One or more cathode wires 122 extend through an inner chamber of the hollow membrane tubes 124 to connect to the cathode end component 126, which is itself connected to the cathode contact 102. In one embodiment, the hollow membrane tubes 124 are formed from NAFION (i.e., a sulfonated tetrafluoroethylene-based fluoropolymer-copolymer (C7HF13O5S C2F4)) (e.g., TT-030 NAFION, TT-050 NAFION, etc.), but one of ordinary skill in the art will understand that other membrane materials, such as perfluorosulfonic acid (PFSA), hydrocarbon-based proton exchange membranes (PEMs), or polymer-based composites are also contemplated herein. The hollow membrane tubes 124 allow for ion transfer between the catholyte and anolyte, while keep the catholyte and anolyte physically separated. In one embodiment, the one or more cathode wires 122 include carbon fiber wires, but one of ordinary skill in the art will understand that other suitable cathodic materials, including carbon nanotubes, are also able to be used for the cathode wires 122.

In one embodiment, the anode body 120 is formed from zinc, which has two distinct advantageous over the most common anode material (i.e., vanadium). Zinc is both cheaper to buy at sizes required and has far improved power density relative to vanadium. Zinc provides for a power density more than an order of magnitude greater than vanadium. However, one of ordinary skill in the art will understand that other materials are able to be used for the anode body 120 as well, including but not limited to vanadium. In one embodiment, the anode body 120 is formed from a solid piece of zinc through which the through-holes for the hollow membrane tubes 124 are made. In one embodiment, the anode contact 104 is connected to a component 127 extending into the solid anode body 120, allowing the anode contact 104 to be directly connected to the solid anode body 120.

The first electrolyte enters through the first electrolyte intake 106 and flows through the inner chambers of the hollow membrane tubes 124 and then exits through the first electrolyte exhaust (not shown in FIG. 2). The second electrolyte enters through the second electrolyte intake (not shown in FIG. 2) and flows through a space between the hollow membrane tubes 124 and the surrounding anode body 120 out of the second electrolyte exhaust 112. Through this entire process, the hollow membrane tubes 124 fully separate the first electrolyte from the second electrolyte, such that the compounds do not mix, but such that transfer of species of the redox reactions are able to occur across the hollow membrane tubes 124.

In one embodiment, the central tubular section 113 is connected to the end sections via threaded connection of ring connectors 114 extending from the central tubular section 113 to a portion of the end sections 115. In one embodiment, one or more sealing elements 128 (e.g., O-rings) are disposed within the threaded connection between the central tubular section 113 to prevent fluid egress out of the reactor 100 body. In one embodiment, the one or more sealing elements 128 include 70A durometer fluoroelastomer O-rings.

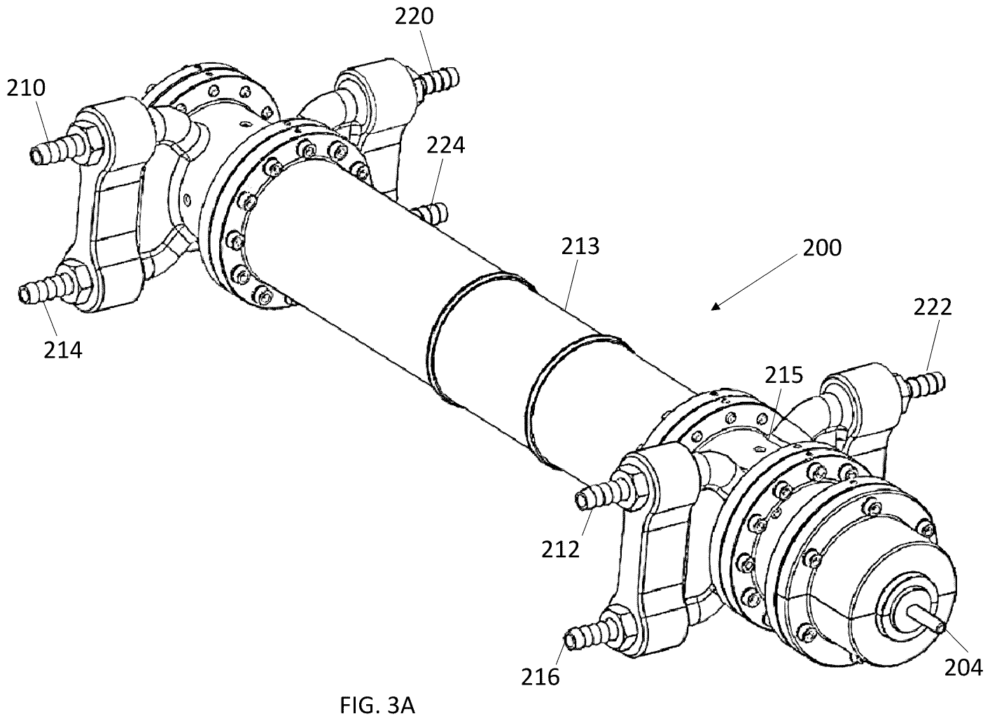

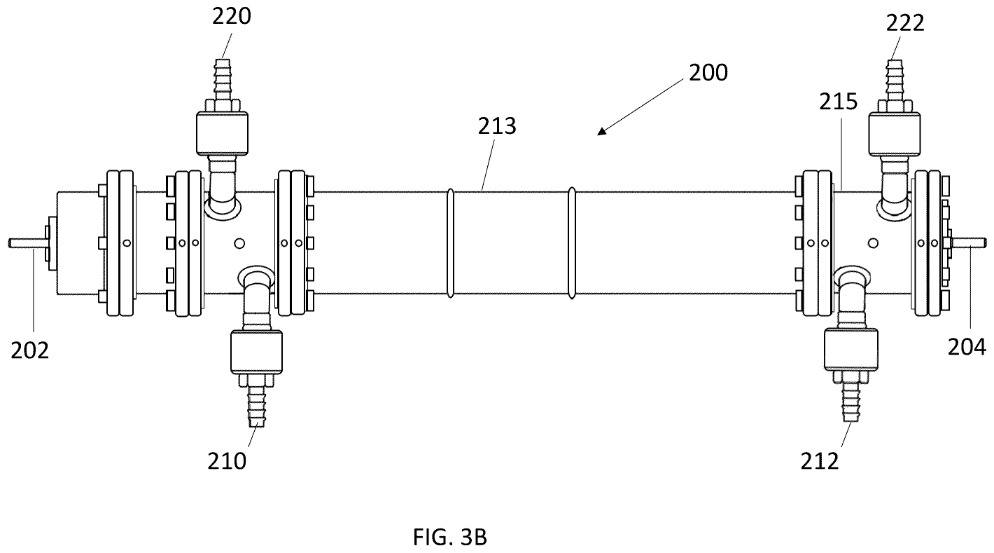

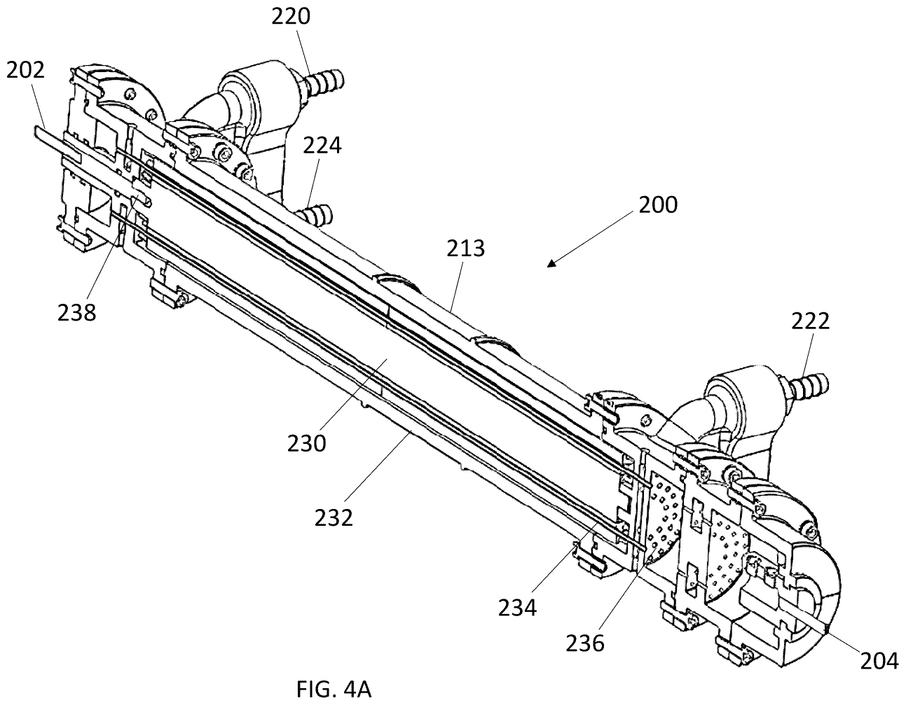

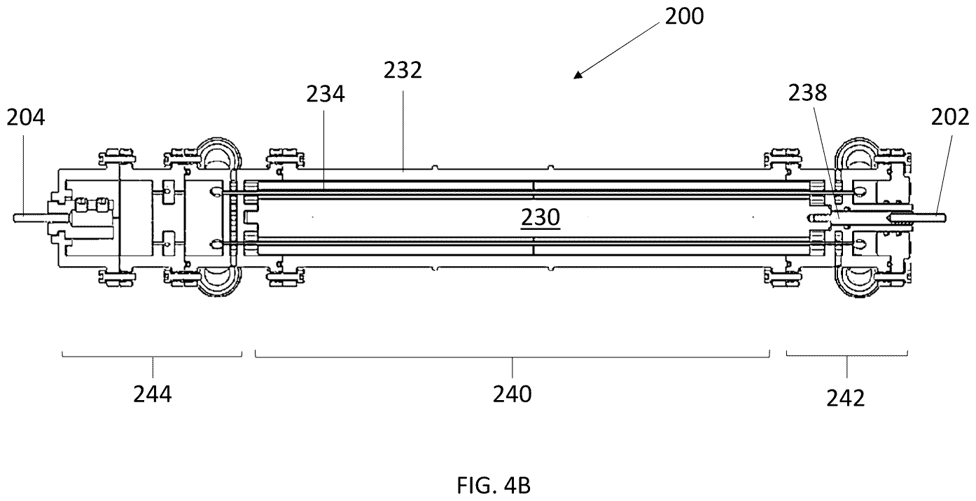

FIGS. 3A and 3B illustrate external views of a reactor for a flow battery according to one embodiment of the present invention. A reactor 200 includes a central tubular section 213 connected to end sections 215. Unlike the threaded connections shown in FIGS. 1A-2, the central tubular section 213 of the embodiment shown in FIGS. 3A-4B is connected to the end sections via one or more bolts or screws. A first electrode contact 204 (either an anode contact or a cathode contact) is shown extending outwardly from the reactor 200.

The reactor shown in FIG. 3A also includes a greater number of electrolyte intakes and electrolyte exhausts than are shown in FIGS. 1A-2. The greater number of ports is able to serve a number of different purposes. In one embodiment, one half of the reactor 200 includes a first electrolyte intake 220 and a second electrolyte intake 224 and a first electrolyte exhaust 222 and a second electrolyte exhaust (not shown). The other half of the reactor 200 then includes an additional first electrolyte intake 210 and an additional second electrolyte intake 214 in addition to an additional first electrolyte exhaust 212 and an additional second electrolyte exhaust 216. Different intakes and exhausts in this embodiment, although transporting the same electrolytes are able to feed different through-holes. This is advantageous as the increased number of flow paths minimizes restrictions to flow. Alternatively, the intakes and exhausts on one half of the reactor are able to be connecting to third and fourth electrolyte tanks such that different through-holes within the same reactor 200 are able to facilitate different half-reactions from other through-holes in the same reactor 200.

FIGS. 4A and 4B illustrate internal, sectional views of a reactor for a flow battery according to one embodiment of the present invention. Similar to the embodiment shown in FIG. 2, a solid anode body 230 extends through a central tubular section 213 of the reactor 200, with an outer shell 232 surrounding the solid anode body 230. Hollow membrane tubes 234 extend through the through-holes 236 in the solid anode body 230. An anode component 238 extends into the solid anode body 230 and is connected to an anode contact 202. Cathodic wires (not shown) extend through the hollow membrane tubes 234 and through a seal to connect with a cathode contact 204 on an end of the reactor 200 opposite the anode contact 202. In one embodiment, the cathodic wires are connected to the cathode contact 204 via one or more screws. In one embodiment, the hollow membrane tubes 234 terminate approximately at the same place as the solid anode body 230 and do not extend to the anode contact 202 or to the cathode contact 204. This is important, as membrane tubes 234 are sensitive and if the tubes were to extend to the ends of the reactor 200, then attempts to fix or replace the anode contact 202 or the cathode contact 204 would potentially result in damage to these tubes 234 and requirement complete replacement of the membrane, increasing cost, time, and difficulty of repair.

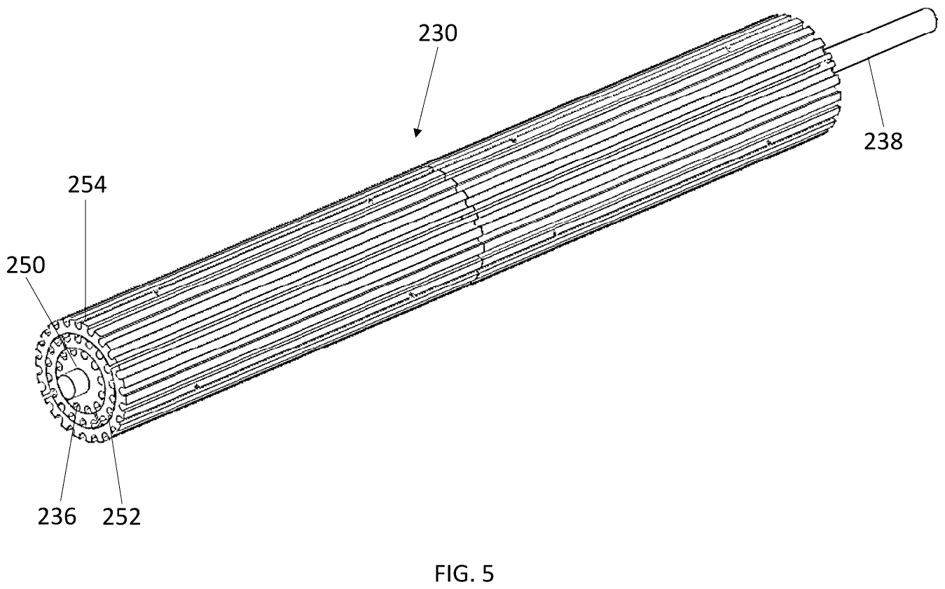

FIG. 5 illustrates a perspective view of an anode body for a reactor for a flow battery according to one embodiment of the present invention. The anode body 230 includes a plurality of through-holes 236 extending through the length of the body 230 and is connected to a contact component 238. In the embodiment shown in FIG. 5, these through-holes 236 are arranged such that the centers of the through-holes 236 are aligned in three concentric rings about a center of the anode body 230. However, this particular embodiment is intended to be illustrative and not limiting. The anode body 230 is able to have greater or fewer numbers of concentric rings. Alternatively, the through-holes 236 are able to not be arranged in concentric rings at all and are able to be arranged in a different pattern or in no particular organized pattern at all. In the embodiment shown in FIG. 5, the anode body 230 is configured with three concentric components with semicircular (or otherwise shaped) notches along the exteriors of the three concentric components, with the outer radius of each component approximately equaling the inner radius of the immediately surrounding component, such that the notches effectively form the through-holes 236 between adjacent components. For example, FIG. 5 shows an inner component 250 having notches adjacent to a middle component 252, which itself has outer notches adjacent to an outer component 254. In one embodiment, the concentric components are connected via one or more down pins oriented at opposing angles. In one embodiment, an epoxy (e.g., silver epoxy) is applied between the concentric components to ensure suitable conductivity between the components.

Alternatively, instead of being formed from separate concentric components, the solid anode 230 is able to be formed from a single piece through which the through-holes are drilled or otherwise formed. In one embodiment, the anode body includes approximately 50 through-holes. In another embodiment, the anode body includes approximately 25 through-holes. In one embodiment, the anode body includes between approximately 4 and approximately 200 through-holes, but one of ordinary skill in the art will understand that the number of through holes is able to be varied as needed.

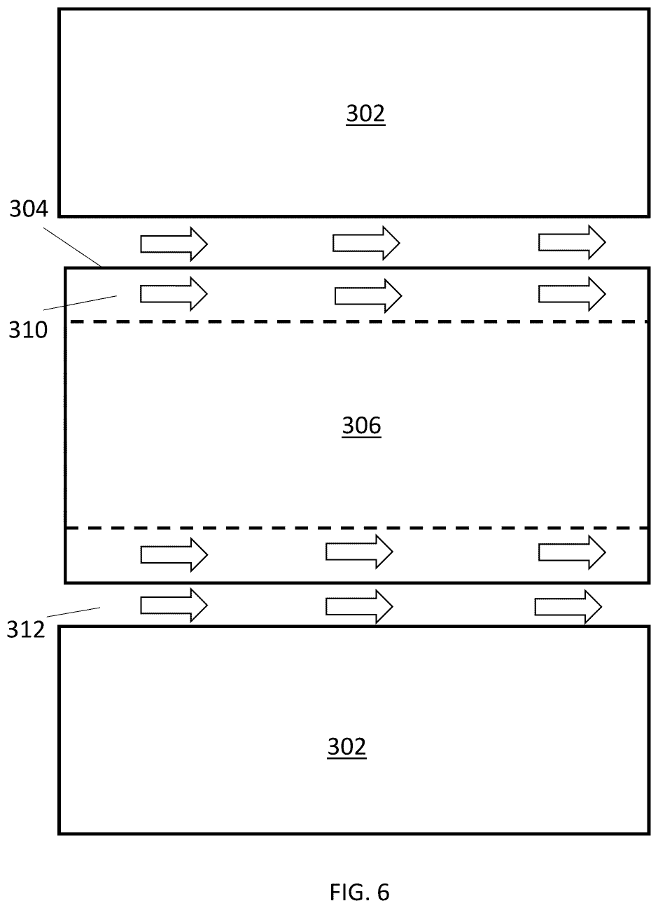

FIG. 6 shows an enlarged schematic view of an ion exchange area of a reactor for a flow battery according to one embodiment of the present invention. A solid anode body 302 includes through-holes through which a hollow membrane tube 304 extends. The hollow membrane tube 304 is configured such that it has a smaller exterior radius relative to the interior radius of the through-hole in which it extends. This means that there is space 312 between the hollow membrane tube 304 and the interior wall of the through-hole of the anode body 302. In this space 312, a first electrolyte (either the catholyte or the anolyte) is able to flow. Within the hollow membrane tube 304, a cathode wire 306 (e.g., a carbon fiber wire) extends. The outer radius of the cathode wire 306 is configured to be lesser than the inner radius of the hollow membrane tube 304 such that a second electrolyte (either the catholyte or the anolyte) is able to flow. The cathode wire 306 and the anode body 302 are connected to the cathode contact and the anode contact, respectively, thereby serving as current collectors along the full length of the reactor as the anolyte and catholyte undergo redox half-reactions based on ion-exchange across the hollow membrane tube 304.

In one embodiment, the length of the reaction area (approximately equal to the length of the hollow membrane tubes) is between approximately 100 mm and approximately 300 mm. In one embodiment, the length of the reaction is approximately 250 mm. However, one of ordinary skill in the art will understand that the sizing of the devices of the present invention is able to be varied as needed and provided at various different scores. In one embodiment, the diameters of the through-holes are approximately 0.075 in, but one of ordinary skill in the art will understand that the specific diameters of through-holes are able to be varied.

In one embodiment, the cathode contact and/or the anode contact are formed from copper (e.g., copper 10100) or a copper alloy.

In one embodiment, the electrolytes used for the present invention is selected from the group consisting of iron-ligand electrolyte, an iron-chloride electrolyte, and iron-chromium electrolyte, a vanadium-based electrolyte, a zinc-based electrolyte, a sulfuric acid-based electrolyte, a hydrochloric acid electrolyte, a zinc-bromide electrolyte, a zinc-iodide electrolyte, a zinc-cerium electrolyte, a zinc-nickel electrolyte, and a zinc-iron electrolyte, such as zinc-ferricyanide.

In one embodiment, the electrolyte includes zinc polyiodide, which is advantageous for its high energy density (greater than 300 Wh/L), comparable to or exceeding other chemistries, such as lithium-based electrolytes, as well as for being non-toxic, non-flammable, and utilizing materials that are abundant in the Earth. Utilization of such a high energy density electrolyte allows for the system of the present invention to synergistical take advantage of both the high power density design of the reactor of the present invention as well as this high energy density, for compounded benefits.

Certain modifications and improvements will occur to those skilled in the art upon a reading of the foregoing description. The above-mentioned examples are provided to serve the purpose of clarifying the aspects of the invention and it will be apparent to one skilled in the art that they do not serve to limit the scope of the invention. All modifications and improvements have been deleted herein for the sake of conciseness and readability but are properly within the scope of the present invention.

The invention claimed is:

1. A flow battery reactor, comprising:
a solid anode body including a plurality of through-holes;
a plurality of hollow membrane tubes extending through the plurality of through-holes;
a plurality of cathode wires extending through the plurality of hollow membrane tubes;
a first electrolyte intake configured to receive a first electrolyte, wherein the first electrolyte flows between interior surfaces of the plurality of through-holes and the plurality of hollow membrane tubes; and
a second electrolyte intake configured to receive a second electrolyte, wherein the second electrolyte flows between the plurality of hollow membrane tubes and the plurality of cathode wires.

2. The reactor of claim 1, wherein the solid anode body comprises zinc.

3. The reactor of claim 1, wherein the plurality of cathode wires includes carbon fiber and/or carbon nanotube wires.

4. The reactor of claim 1, wherein the plurality of hollow membrane tubes include sulfonated tetrafluoroethylene-based fluoropolymer-copolymer membrane tubes.

5. The reactor of claim 1, further comprising an outer shell surrounding and encasing the solid anode body.

6. The reactor of claim 1, wherein the plurality of cathode wires are connected to a cathode contact positioned at a first end of the reactor.

7. The reactor of claim 1, wherein the solid anode body is connected to an anode contact extending outwardly from a second end of the reactor.

8. The reactor of claim 1, wherein the solid anode body includes a plurality of concentric cylindrical subunits, each including semicircular notches along an exterior surface.

9. A flow battery reactor, comprising:
an outer shell surrounding a solid anode body, wherein the solid anode body includes a plurality of through-holes;
a plurality of hollow membrane tubes extending through the plurality of through-holes;
a plurality of cathode wires extending through the plurality of hollow membrane tubes connected to a cathode contact extending from a first end of the reactor; and
an anode contact connected to the solid anode body extending from a second end of the reactor.

10. The reactor of claim 9, wherein the solid anode body comprises zinc.

11. The reactor of claim 9, wherein the plurality of cathode wires includes carbon fiber and/or carbon nanotube wires.

12. The reactor of claim 9, wherein the plurality of hollow membrane tubes include sulfonated tetrafluoroethylene-based fluoropolymer-copolymer membrane tubes.

13. The reactor of claim 9, wherein the solid anode body includes a plurality of concentric cylindrical subunits, each including semicircular notches along an exterior surface.

14. The reactor of claim 9, further comprising a first electrolyte intake configured to receive a first electrolyte and a first electrolyte exhaust configured to output the first electrolyte from the reactor.

15. The reactor of claim 9, further comprising a second electrolyte intake configured to receive a second electrolyte and a second electrolyte exhaust configured to output the second electrolyte from the reactor.

16. The reactor of claim 9, wherein the outer shell comprises a plastic material.

17. A flow battery reactor, comprising:
a solid anode body, wherein the solid anode body includes a plurality of through-holes;
a plurality of hollow membrane tubes extending through the plurality of through-holes; and
a plurality of cathode wires extending through the plurality of hollow membrane tubes;
wherein the solid anode body comprises zinc; and
wherein the plurality of cathode wires includes carbon fiber and/or carbon nanotube wires.

18. The reactor of claim 17, wherein the plurality of hollow membrane tubes include sulfonated tetrafluoroethylene-based fluoropolymer-copolymer membrane tubes.

19. The reactor of claim 17, wherein the solid anode body includes a plurality of concentric cylindrical subunits, each including semicircular notches along an exterior surface.

20. The reactor of claim 17, further comprising a first electrolyte intake configured to receive a first electrolyte and a first electrolyte exhaust configured to output the first electrolyte from the reactor, and a second electrolyte intake configured to receive a second electrolyte and a second electrolyte exhaust configured to output the second electrolyte from the reactor.
